(19) United States
(12) Patent Application Publication
(10) Pub. No.: US 2018/0095719 A1
(43) Pub. Date: Apr. 5, 2018

(54) SORTED LINKED LIST WITH A MIDPOINT BINARY TREE

(71) Applicant: Michael Winestock, Grand Rapids, MI (US)

(72) Inventor: Michael Winestock, Grand Rapids, MI (US)

(21) Appl. No.: 15/284,049

(22) Filed: Oct. 3, 2016

(51) Int. Cl. G06F 7/08; G06F 17/30

(52) U.S. Cl. CPC G06F 7/08; G06F 17/30377; G06F 17/30961; G06F 17/30958

(57) ABSTRACT

A system and method for implementing a sorted linked list with a midpoint binary tree pointer is described herein. The midpoint binary tree pointer contains a predetermined level, with the level being associated with dynamically rebalanced midpoints that bifurcate the sorted linked list into a variety of segments. By doing this, the implementer of these systems and methods achieves a faster way of accessing and creating stored linked lists.

### BACKGROUND

Data storage in the field of electronics is vital to how information is shared and utilized. In certain cases, the data is static and stored in non-volatile memory architecture. As such, the data may be accessed even after power is lost. In other cases, data may be stored in a dynamic memory scheme, and accessed when an electronic system is powered.

In either case, the efficiency of the data storage and providing some sort of access scheme allows for data access to be quicker, and ultimately, provide a more robust user experience. However, with every data storage technique, the following parameters need to be optimized, speed of access and amount of space or storage resources required.

Various techniques have been provided and disclosed to teach data storage. These techniques each are accompanied with a variety of advantages and disadvantages, with each technique being applied in certain situations contingent on the implementer's preferences and needs.

One such data storage technique is the linked list. The linked list is a linear collection of data elements (called nodes), with each node referring to a next node via an element called a pointer.

FIG. 1 illustrates a sample linked list 100 according to a prior art implementation. The linked list 100 includes data 101a, 102a, 103a, and nodes 101b, 102b, and 103b. Connecting each of the nodes is a pointer 101c, 102c, and 103c. Pointer 103c ultimately points to terminal node 104.

As show in FIG. 1, there are three data values (which are exemplary). As data is added to the set or taken away, a new pointer is provided. In this way, data can be added and removed in a dynamic fashion.

The advantages of a linked list are numerous, and include the following:
1) Linked lists are dynamic, which can grow and be pruned while the program is running.
2) Insertion and deletion node operations are easily implemented in a linked list.
3) Linear data structures such as stacks and queues are easily executed with a linked list.

However, with any data storage technique, there are also disadvantages. In some cases, the linked lists are difficult to traverse. As the linked lists are not sorted inherently, in order to manage the data, the linked list 100 requires traversing every element to perform the search. As such, searching linked list may take numerous computer resources and user time.

Another example of a data storage technique is the binary tree. FIG. 2 illustrates a binary tree 200. As shown in the binary tree nodes 201-210 each include a value and at least one pointer (with a maximum of two pointers). When the tree is sorted, a user can start from the root node (node 201), and traverse down the tree to find a value. Each node may be a parent node (for example, node 203 may be classified as a parent), and have two child nodes (204 and 205).

In some cases, the binary tree 200 may be sorted and balanced. This essentially means that when a system traverses the binary tree, for example follows a specific node down the left or right side, the following property is maintained: the left node is smaller while the right node is larger than originating node.

However, in other cases (not shown), a binary tree 200 may be unsorted. Various algorithms conventionally known may be employed to sort (or balance) the binary tree.

### SUMMARY

The implementation of a sorted linked list with a midpoint binary tree pointer is described herein. The midpoint binary tree pointer contains a predetermined number of levels, with the level being associated with dynamically rebalanced midpoints that bifurcate the sorted linked list into a variety of segments. By doing this, the implementer of these systems and methods achieves a faster way of accessing and creating stored linked lists.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a sample linked list according to a prior art implementation.

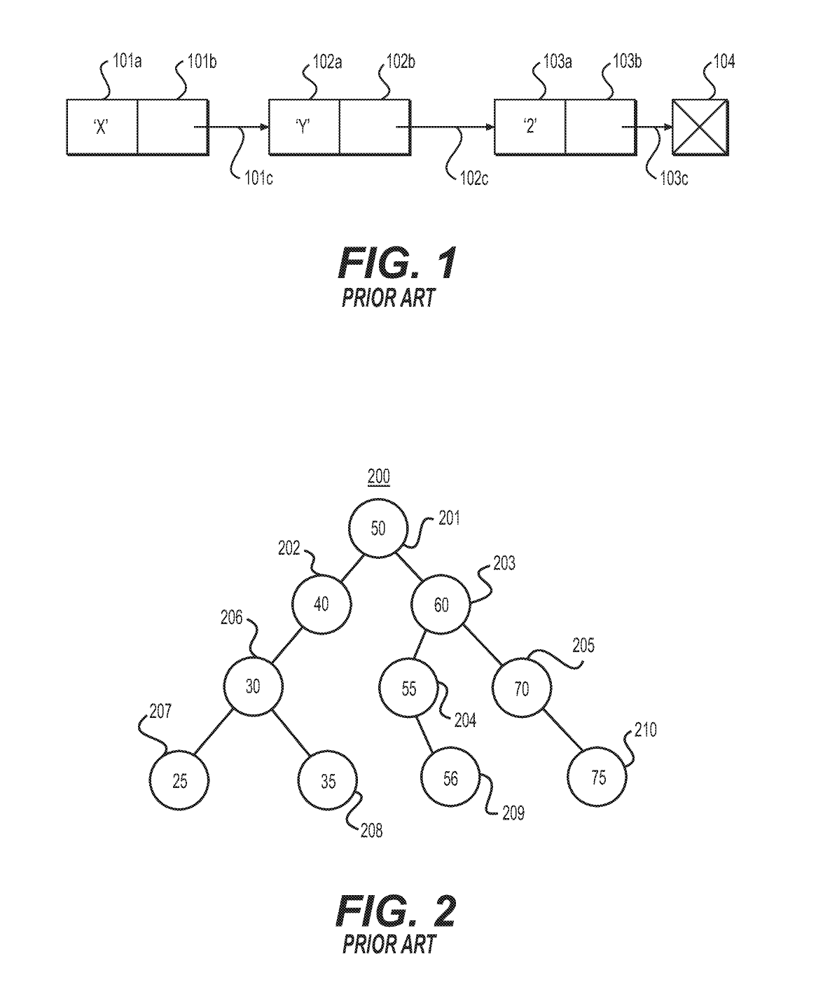

FIG. 2 illustrates a sample binary tree according to a prior art implementation.

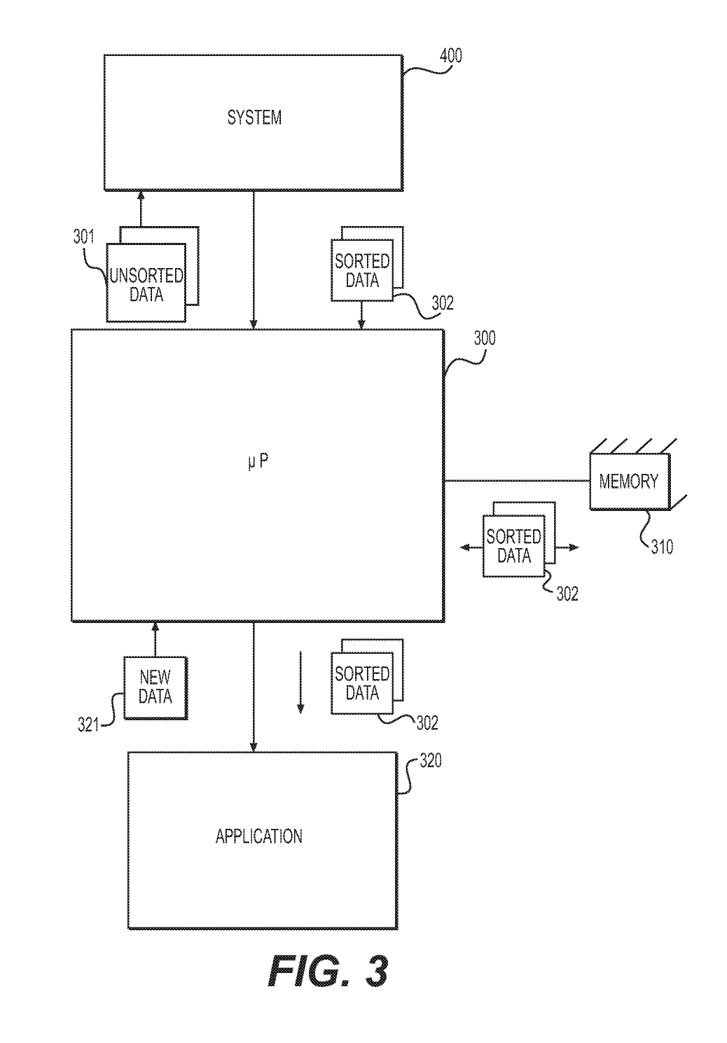

FIG. 3 illustrates an example computer-processor employing a memory system according to the aspects disclosed herein.

FIG. 4 illustrates an example of the system shown in FIG. 3.

FIG. 5 illustrates an example of an operation of the system shown in FIG. 4.

FIGS. 5-9 illustrate an example implementation of the system in FIG. 4.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

The sorting of data to provide an efficient way to retrieve and use said data is paramount in the operation of a machine or computer. The more efficient the data is stored, with employable methods to access said data, a computer or application may run faster and in a more efficient manner. This allows graphics to be displayed quicker, applications to run smoother, and in certain cases, provide a better user experience.

As explained in the Background section, techniques known to one of ordinary skill in the art exist that have been devised in computer science arts to traverse, organize, and use data. However, each of these techniques come with advantages and disadvantages, and as such, may be ideal for one implementation and not for another.

Disclosed herein are methods and systems for employing a linked list with a binary tree pointing scheme, to provide data access in a more efficient and faster method. By employing the techniques disclosed herein, various applications and computer hardware may be provided in a more efficient manner. The aspects disclosed herein provide for data retrieval and usage in markedly improved manners. The inventors have shown that the usage of the data techniques provided herein, especially information processing, lead to faster and more efficient processing of data. However, the aspects disclosed herein may be employed in a variety of computer processing related applications.

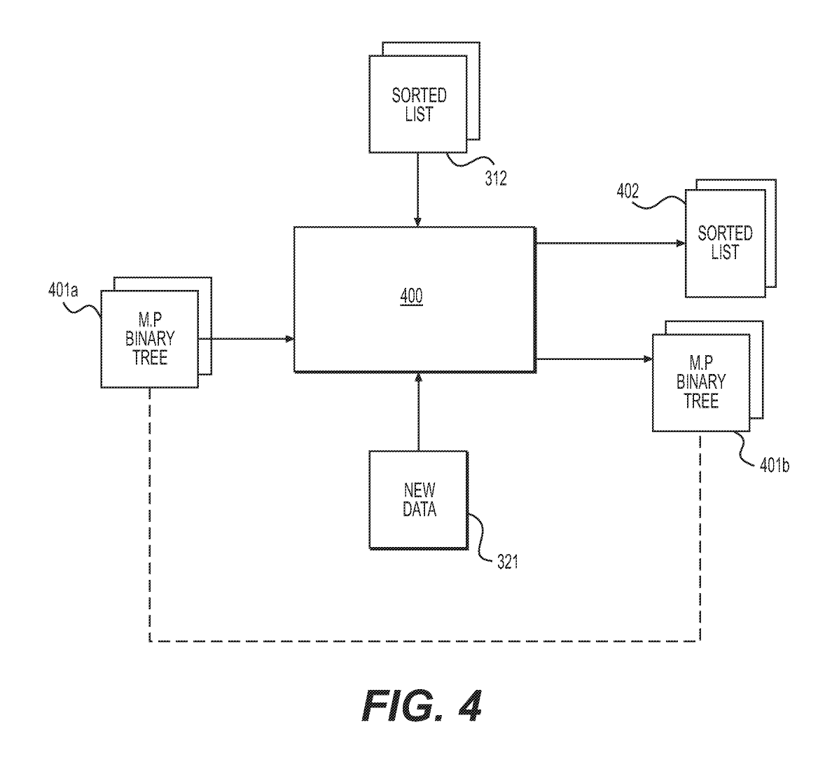

FIG. 3 illustrates an example computer-processor 300 employing a memory system 310 according to the aspects disclosed herein. The computer-processor 300 includes system 400 (which will be described in greater detail below). The memory system 310 may employ any memory architecture known to one of ordinary skill in the art.

Also shown in FIG. 3 is application 320. The application 320 may be any computer program executable via the computer-processor 300. The application 320 may generate data dynamically based on how the user interacts with the computer-processor 300, which is shown by the propagation of new data 321 to the computer-processor 300. The computer-processor 300, in turn, may append said new data 321 to the sorted data 302, and create unsorted data 301.

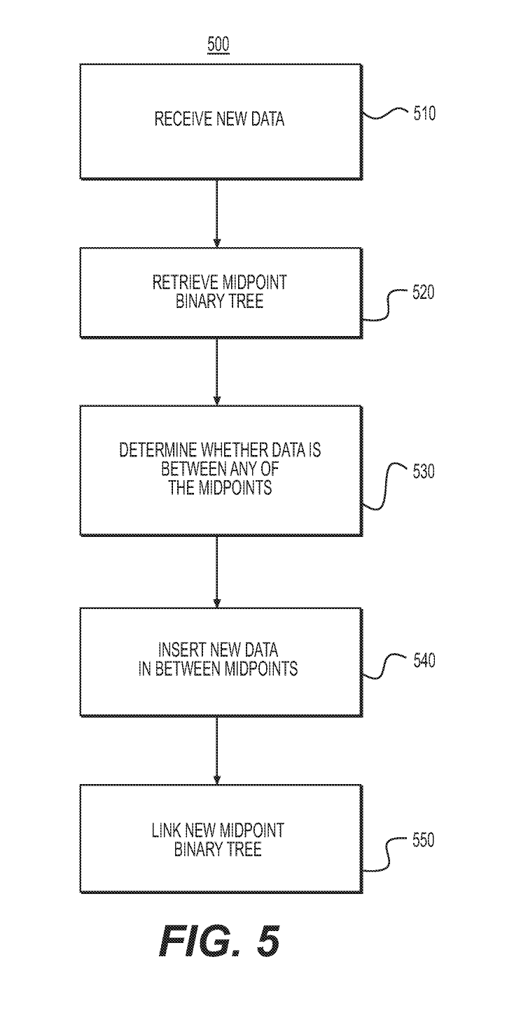

The unsorted data 301 is inputted into the system 400, which in turn, may employ the aspects disclosed herein to create sorted data 302. The creation of sorted data 302 by the techniques shown in FIG. 4 define the operations of sorting and employing the linked lists with a binary tree pointing system disclosed herein.

As a result, the sorted data 302 may be stored in the dynamic memory system 310 and recalled by the application 320 (or another application) for a variety of use cases associated with the operation of the computer-processor 300.

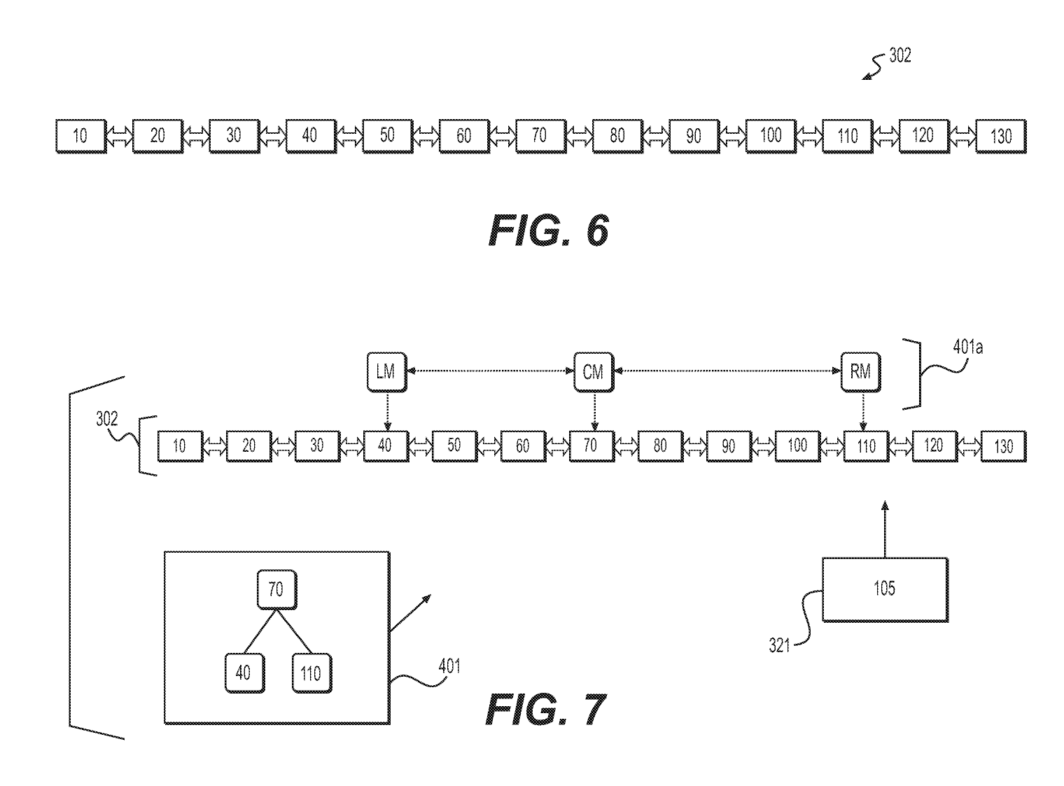

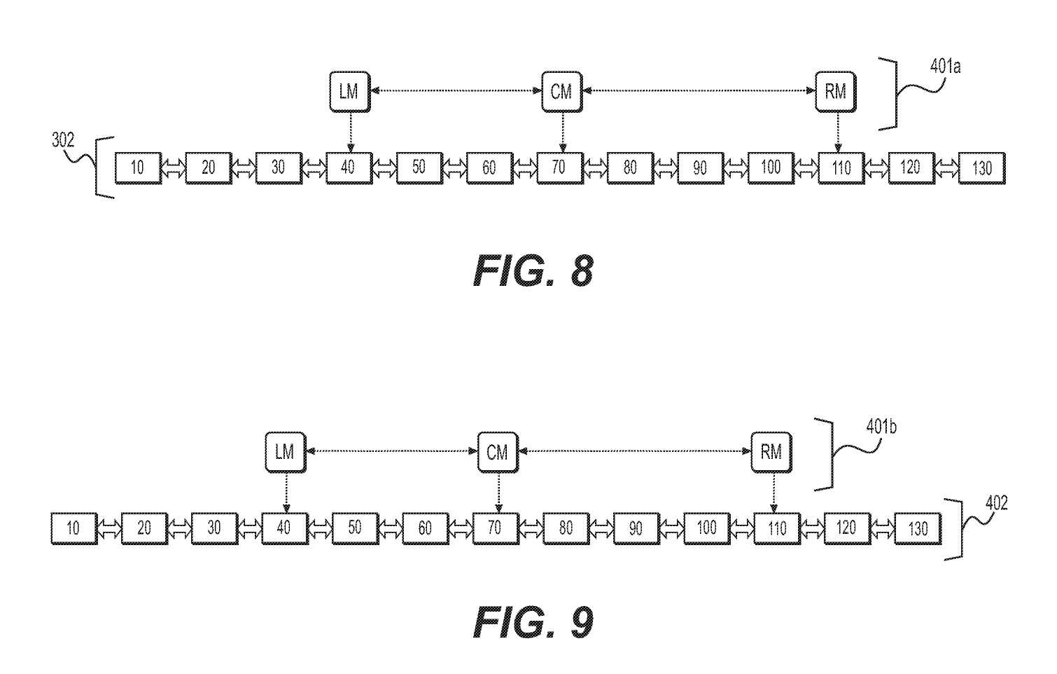

FIG. 5 illustrates an implementation of the system 400 via flow diagram 500. As shown in flow diagram 500, the various operations and methods for sorting unsorted data 301 are provided. Corresponding to FIG. 5 is FIG. 4, which shows system 400 and the various data types employed for an implementation. The explanation of flow diagram 500 will refer back to the elements shown in FIG. 4 for illustrative purposes.

In operation 510, new data is received to insert into a sorted linked list 302 according to the aspects disclosed herein. The sorted linked list 302 is sorted using the aspects explained with method 500, and as such, each employ a sorted linked list 302 and an associated midpoint binary tree 401a.

In operation 520, the midpoint binary tree 401a is retrieved. The midpoint binary tree 401a is associated with the sorted linked list 302 already created, and has been set up employing the aspects disclosed herein.

In certain cases, the midpoint binary tree 401a will not exist. An implementer of system 400 may preset the level of the binary tree. As noted, a level of the binary tree will have the following amount of nodes−>2 to the power of the level −1. As such, if the implementer uses a level 2 binary tree, the example number of nodes of the midpoint binary tree 401a will be 3.

In the case that the number of data points in the linked list 302 is less than the number of nodes associated with the level of the midpoint binary tree 401a (i.e., in the case of level 2, the number of nodes being 3), the midpoint binary tree 401a would not be employed or created until at least three items of data are received to populate the sorted linked list with.

The midpoint binary tree 401a is a binary tree with pointers to various midpoints of the sorted linked list 302. Each midpoint bifurcates the linked list 302 into two smaller linked lists. The left child of a parent node is the first of the two bifurcated linked lists (i.e. the lower values) midpoint. The right child of a parent node is the second the two bifurcated link lists (i.e. the upper values) midpoint.

As indicated, an implementer of system 400 may choose the number of the levels used. In one implementation, the level number of the midpoint binary tree 401a may dynamically update after a predetermined number of data is entered. For example, the number or midpoints may be tied to the amount of data included in the sorted linked list 302.

In operation 530, an operation is performed to determine whether the new data is in between any of the midpoints associated with the midpoint binary tree 401a, or between a start value and a midpoint, or an end value and midpoint.

In operation 540, once the above upper and lower limits associated with where the new data 321 is found to be within is determined, the new data 321 is properly inserted in the right location of the sorted linked list 302, thereby creating a new sorted linked list 402. When new data is added, the new sorted linked list 402 is treated as the sorted linked list 302 in operations 510-530.

In operation 550, the midpoint binary tree 550 is updated (rebalanced) to create a new updated midpoint binary tree 401b. As such, the midpoints may be pointed to new nodes of the linked list to adjust to the fact that the sorted linked list 402 has updated.

FIGS. 6-9 illustrate an example of an implementation of system 400 according to an exemplary embodiment. The number of data elements employed, the level of the midpoint binary trees is all exemplary. As such, an implementer of the system 400 may determine an optimal number to use.

As shown in FIG. 6, a sorted linked list 302 is provided. The sorted linked list 302 includes sorted data, with the data being sequentially presented. The sorted linked list 302 operates similar to the linked list shown above with respect to customary linked lists known to one of ordinary skill in the art.

In FIG. 7, the sorted linked list 302 is shown with a midpoint binary tree 401a. The midpoint binary tree 401a is shown in tree form, and as associated with the specific sorted linked list 302 shown. As shown, the level of the point binary tree 401a in this example is 2 (thus, showing three midpoints). The three midpoints (a left midpoint, a center midpoint, and a right midpoint), each point to a specific midpoint of the sorted linked list 302 according the aspects disclosed herein.

Specifically, the center midpoint is pointing at the center of the sorted linked list 302. As such, two halves are created. The left and right midpoints each point at midpoints of the resultant halves.

As shown in FIG. 7, a new data node 321 is being entered into the sorted linked list 302. Employing conventional techniques, a linked list organizing methodology would be required to traverse each element of the linked list 302 to enter the new data node 321 into the appropriate location to maintain a sorted linked list.

In the example provided, new data node 321 is associated with value 105. According to the aspects disclosed herein, the system 400 (employing method 500) performs the aspects disclosed herein to insert the data into the appropriate location of the new linked list 402 shown in FIG. 8. As such, the following progression may occur:

1) New data 321 is compared to the element associated with the center midpoint of the midpoint binary tree 401a. As such, because 105 is larger than 70, the system 400 proceeds to analyze the midpoint on a right child node.

2) Once again, new data 321 is compared to the right midpoint, and as such, the new data 321 is determined to be less than the value of the right midpoint (110). Thus, the system 400 knows to insert the data in between the right midpoint and the center midpoint.

3) The data in between the center midpoint and right midpoint is traversed, and new data 321 is inserted in a manner to maintain a sorted linked list, thereby producing linked list 402 as shown in FIG. 8.

In FIG. 9, the midpoint binary tree 401a is rebalanced, and as such, the new midpoint binary tree 401b is produced. As shown, the new center midpoint is now pointing at the value 80.

In another implementation, the binary tree level may dynamically update when triggered by a predetermined amount of data points being employed in the sorted linked list 302/402. As such, another level of midpoints may be dynamically calculated and associated with the sort linked lists shown.

Additionally, each of the midpoints shown may be stored along with an offset. In certain cases, the midpoint is incapable of bifurcating a segment into two equal parts. As such, an offset may be introduced in addition to storing each midpoint. The offset may be a positive value 1 (indicating more data on one end), negative value (indicating more data on the opposing end), and 0 (indicating an equal amount on both ends).

As such, employing the aspects disclosed herein, an implementer of the systems and method disclosed herein may achieve faster data storage and retrieval. Thus, a computer system may utilize sorted linked lists in a manner that is efficient, without having to manual traverse each element of a linked list to perform the sorting operation.

Certain of the devices shown include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIG. 5. The disclosed devices, components, and systems contemplate using or implementing any suitable technique for performing the steps illustrated in these figures. Thus, FIG. 5 is for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for implementing a sorted linked list with a midpoint binary tree, the system comprising:
a data store comprising a non-transitory computer readable medium storing a program of instructions for the implementation of the sorted linked list;
a processor that executes the program of instructions, the instruction comprising the following steps:
receiving new data to insert into the sorted linked list;
retrieving the midpoint binary tree;
determining, based on the retrieved midpoint binary tree, where to insert the new data via the sorted linked list; and
inserting the new data into the sorted linked list, thereby producing an update sorted linked list.

2. The system according to claim 1, further comprising rebalancing the midpoint binary tree in response to the insertion of the new data.

3. The system according to claim 2, wherein a level of the midpoint binary tree is predetermined, and based on the level, a plurality of segments of the sorted linked list is created, with the plurality of segments being defined by each of a plurality of midpoints associated with the midpoint binary tree.

4. The system according to claim 3, wherein in response to receiving the new data, the system is configured to determine which of the plurality of segments the data belongs to by traversing the binary tree.

5. The system according to claim 4, wherein each of the plurality of midpoints each includes an offset value, the offset value being defined by whether segment being bifurcated by the respective midpoint creates an uneven number on both ends of the segment.

6. The system according to claim 3, wherein the level is dynamically updated based on the insertion of new data causing the sorted linked list to be over a predetermined number.

7. A method for implementing a sorted linked list with a midpoint binary tree, the system comprising:
receiving new data to insert into the sorted linked list;
retrieving the midpoint binary tree;
determining, based on the retrieved midpoint binary tree, where to insert the new data via the sorted linked list; and
inserting the new data into the sorted linked list, thereby producing an update sorted linked list.
further comprising rebalancing the midpoint binary tree in response to the insertion of the new data.

8. The method according to claim 7, wherein a level of the midpoint binary tree is predetermined, and based on the level, a plurality of segments of the sorted linked list is created, with the plurality of segments being defined by each of a plurality of midpoints associated with the midpoint binary tree.

9. The method according to claim 8, wherein in response to receiving the new data, determining which of the plurality of segments the data belongs to by traversing the binary tree.

10. The method according to claim 9, wherein each of the plurality of midpoints each includes an offset value, the offset value being defined by whether segment being bifurcated by the respective midpoint creates an uneven number on both ends of the segment.

11. The method according to claim 9, wherein the level is dynamically updated based on the insertion of new data causing the sorted linked list to be over a predetermined number.
